(19) United States
(12) Patent Application Publication
(10) Pub. No.: US 2011/0084897 A1
(43) Pub. Date: Apr. 14, 2011

(54) ELECTRONIC DEVICE

(75) Inventors: Mohanraj MANOHARAN, C.I.T. Nagar (IN); Rajeev REMA SHANMUGAM, Thiruvanmiyur (IN)

(73) Assignee: Sony Ericsson Mobile Communications AB, Lund (SE)

(21) Appl. No.: 12/577,764

(22) Filed: Oct. 13, 2009

(51) Int. Cl. G09G 5/00

(52) U.S. Cl. 345/156

(57) ABSTRACT

An electronic device is disclosed. The electronic device comprises a distance sensor for sensing a distance between the electronic device and a face of a user of the electronic device, an image sensor for providing an image of the face of the user, and a display for displaying text and/or graphical objects. The electronic device further comprises a control unit operatively connected to the display for controlling the displaying of text and/or a graphical object thereon, to the distance sensor for receiving distance data indicative of said distance, and to the image sensor for receiving image data representing said image. The control unit is adapted to control a font size of said text and/or a size of said graphical object based on the distance data and/or the image data.

### TECHNICAL FIELD

The present invention relates to an electronic device having a display for displaying text and/or graphics.

### BACKGROUND

Portable electronic devices, such as mobile telephones and smartphones, have gained an increased popularity over the last years, and their popularity continues to increase. Such portable electronic devices are normally equipped with a display for displaying text and/or images. A problem that might occur is that a user's visual perception of the displayed text may be impaired under various conditions, especially if the user has a visual defect such as short sightedness or long sightedness.

### SUMMARY

According to an aspect of the present invention, there is provided an electronic device comprising a distance sensor for sensing a distance between the electronic device and a face of a user of the electronic device, an image sensor for providing an image of the face of the user, and a display for displaying text and/or graphical objects. Furthermore, the electronic device comprises a control unit. The control unit is operatively connected to the display for controlling the displaying of text and/or a graphical object thereon. Furthermore, the control unit is operatively connected to the distance sensor for receiving distance data indicative of said distance. Moreover, the control unit is operatively connected to the image sensor for receiving image data representing said image. The control unit is adapted to control a font size of said text and/or a size of said graphical object based on the distance data and/or the image data.

The control unit may be adapted to control the font size and/or the size of said graphical object based on the distance data such that the font size and/or the size of said graphical object increases with an increasing distance between the electronic device and the face of the user.

The control unit may be adapted control the font size and/or the size of said graphical object based on the distance data such that the font size and/or the size of said graphical object increases with an increasing absolute difference between said distance between the electronic device and the face of the user and a threshold distance.

The distance data may comprise, for each of a plurality of directions, data indicative of a distance between the electronic device and an object closest to the electronic device in that direction, and the control unit may be adapted to determine which of said directions is the direction towards the users face based on the image data.

Alternatively, said distance data indicative of the distance between the electronic device and the face of the user may be data indicative of the distance from the electronic device and the object closest to the electronic device that can be sensed by the distance sensor.

The control unit may be adapted to determine a current gesture of an eye of the user based on the image data and to control the font size and/or the size of said graphical object based on the determined current gesture.

The control unit may be adapted to determine whether the determined current gesture belongs to a first set of gestures or a second set of gestures. Furthermore, the control unit may be adapted to control the font size and/or the size of said graphical object such that the font size and/or the size of said graphical object is larger if the determined current gesture belongs to the second set of gestures than if the determined current gesture belongs to the first set of gestures. The first set of gestures may indicate that the user's eye is relaxed, and the second set of gestures may indicate that the user's eye is peering.

The control unit may be adapted to, in a calibration routine of the control unit, prompt the user to perform a plurality of eye gestures, and fetch, from the image sensor, one or more images of the user for each gesture performed by the user.

The control unit may be adapted to determine the current gesture of the user's eye by comparing one or more characteristics of the image data received from the image sensor with one or more corresponding characteristics of image data representing the images fetched from the image sensor during the calibration routine.

The electronic device may be a portable electronic device. Further embodiments of the invention are defined in the dependent claims.

It should be emphasized that the term “comprises/comprising” when used in this specification is taken to specify the presence of stated features, integers, steps, or components, but does not preclude the presence or addition of one or more other features, integers, steps, components, or groups thereof.

### BRIEF DESCRIPTION OF THE DRAWINGS

Further objects, features and advantages of embodiments of the invention will appear from the following detailed description, reference being made to the accompanying drawings, in which:

FIG. 1 is a view of a portable electronic device according to an embodiment of the present invention;

FIG. 2 schematically illustrates a portable electronic device according to an embodiment of the present invention together with a user of the portable electronic device;

FIG. 3 is a block diagram of a portable electronic device according to an embodiment of the present invention;

FIGS. 4-8 schematically illustrate a font size as a function of distance between a portable electronic device and the face of a user of the portable electronic device according to various embodiments of the present invention; and

FIGS. 9-10 schematically illustrate different eye gestures of a user of a portable electronic device according to examples.

### DETAILED DESCRIPTION

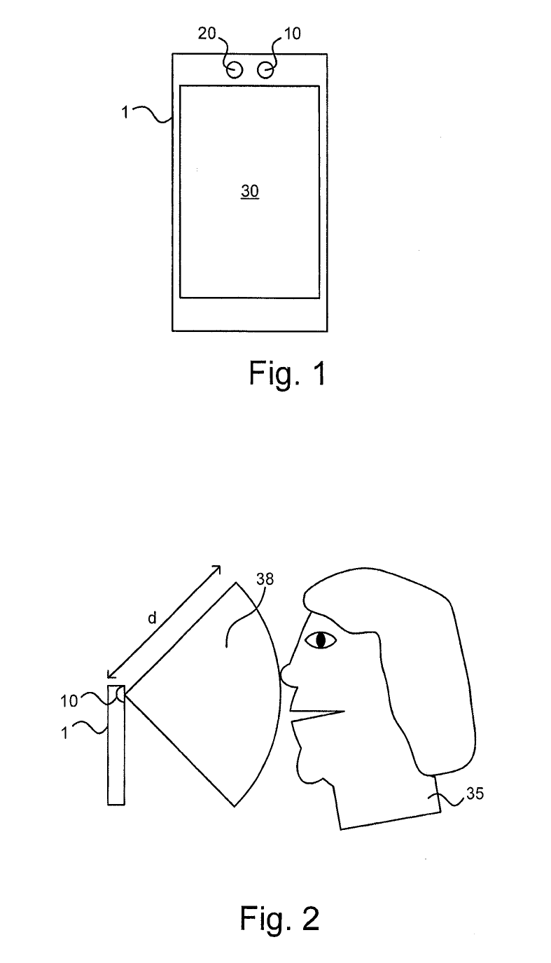

FIG. 1 is a view (“front view”) of a portable electronic device 1 according to an embodiment of the present invention. The portable electronic device 1 may e.g. be, but is not limited to a mobile telephone, such as a “low-end” mobile telephone or a “smart phone”, a portable digital assistant (PDA), a portable e-book reader, or a laptop or netbook computer. According to the embodiment, the portable electronic device 1 comprises a distance sensor 10. Furthermore, according to the embodiment, the portable electronic device 1 comprises an image sensor 20. The image sensor 20 may e.g. be or comprise a CCD (Charge-Coupled Device) or CMOS (Complementary Metal-Oxide-Semiconductor) image sensor, but is not limited thereto. Furthermore, the image sensor 20 may be, comprise, or form part of a digital camera of the portable electronic device 1. Moreover, according to the embodiment, the portable electronic device 1 comprises a display 30 for displaying text. The display 30 may additionally be adapted to display graphics as well.

FIG. 2 schematically illustrates the portable electronic device 1 together with a user 35 of the portable electronic device 1. The image sensor 20 (FIG. 1) is adapted to provide an image of the face of the user 35. Furthermore, the distance sensor 10 is adapted to sense a distance d between the portable electronic device 1 and a face of the user 35. For example, in some embodiments, the face of the user 35 is assumed to be the closest object that is within a detection sector 38 of the distance sensor 10. Alternatively, the distance sensor 10 may be adapted to sense, for each of a plurality of directions, the distance to the closest object in that direction. Image recognition may be applied to an image obtained by means of the image sensor 20 to recognize which of these directions is a direction towards the face of the user, thereby facilitating the determination of the distance between the portable electronic device 1 and the face of the user 35 by selecting the distance sensed by the distance sensor in such a direction.

According to embodiments of the present invention, the distance sensor may be or comprise one or more proximity sensors, such as but not limited to one or more IR (infrared) proximity sensors, one or more ultrasonic proximity sensors, and/or one or more photoelectric proximity sensors. According to one embodiment, wherein a photoelectric proximity sensor is employed, the light from the display 30, reflected by the user's 35 face to the photoelectric proximity sensor is utilized for determining the distance.

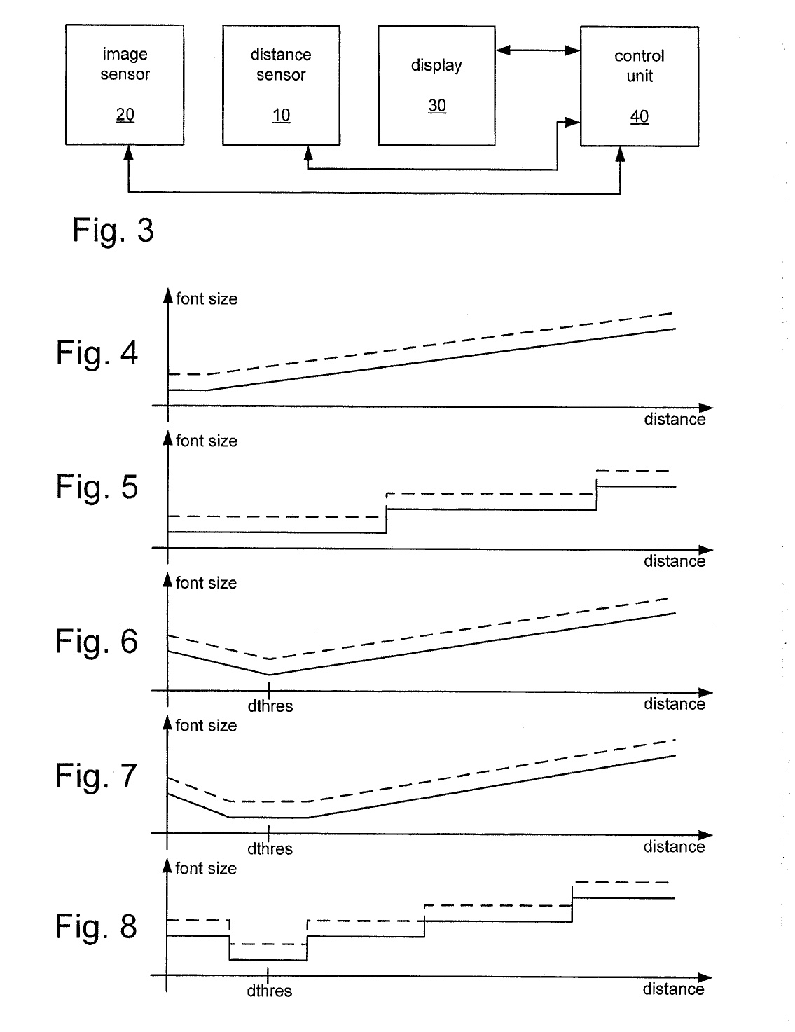

FIG. 3 is a block diagram of the portable electronic device 1 according to an embodiment of the present invention. In addition to the distance sensor 10, image sensor 20, and display 30, the embodiment of the portable electronic device 1 illustrated in FIG. 3 comprises a control unit 40. The control unit 40 is operatively connected to the display 30 for controlling the displaying of text thereon. Furthermore, the control unit 40 is operatively connected to the distance sensor 10 for receiving data indicative of said distance d. Moreover, the control unit 40 is operatively connected to the image sensor 20 for receiving image data representing said image of the face of the user 35. According to embodiments of the present invention, the control unit 40 is adapted to control a font size of said text displayed on the display 30 based on the distance data and/or the image data. Thereby, it is possible compensate for conditions that may otherwise impair the user's 35 ability to visually perceive the displayed text, as is outlined with a number of examples and embodiments below.

As hinted above, the distance data indicative of the distance between the portable electronic device 1 and the face of the user 35 may be data indicative of the distance from the portable electronic device 1 and the object closest to the portable electronic device 1 that can be sensed by the distance sensor 10. Alternatively, as is also hinted above, the distance data may comprise, for each of a plurality of directions, data indicative of a distance between the portable electronic device 1 and an object closest to the portable electronic device 1 in that direction. In that case, the control unit 40 may be adapted to determine which of said directions is the direction towards the user's 35 face based on the image data received from the image sensor 20, e.g. by applying a face-recognition technique on said image data.

FIGS. 4-8 schematically illustrate how the font size may be varied as a function of the distance d between the portable electronic device 1 and the face of the user 35 according to various embodiments of the present invention. Each of the FIGS. 4-8 illustrates two different curves, one solid and one dashed, exemplifying similar dependencies between the distance d and the font size.

According to some embodiments, the control unit 40 is adapted to control the font size based on the distance data such that the font size increases with an increasing distance between the portable electronic device 1 and the face of the user 35. This way of controlling the font size improves the user's 35 ability to perceive the displayed text as the distance increases. This may e.g. be particularly helpful for a near-sighted user 35, although all types of users 35 may benefit from it. This type of control is illustrated in FIGS. 4 and 5. In FIG. 4, the font size is kept at a constant minimum value when the distance is below a certain level. As the distance increases above that level, the font size is continuously increased with increasing distance. In FIG. 5, the situation is the same as in FIG. 4, except that the font size is increased in steps rather than continuously.

According to some embodiments, the control unit is adapted control the font size based on the distance data such that the font size increases with an increasing absolute difference between said distance and a threshold distance, which is denoted dthres in FIGS. 6-7 that illustrates examples of this type of control. This means that when the portable electronic device is held at a certain distance “far away” (further away than dthres) from the user's 35 face, the font size increases with increasing distance. This has the same benefits as the control described above with reference to FIGS. 4 and 5. On the other hand, when the portable electronic device 1 is held at another certain distance “close” (closer than dthres) to the user's 35 face, the font size instead increases with decreasing distance. This may be particularly useful e.g. for an over-sighted user 35 that may otherwise have difficulties perceiving the displayed text when the portable electronic device is held relatively close to his/her face.

In the example of FIG. 6, the font size is at a minimum at the distance dthres. Furthermore, the font size increases continuously with increasing distance above the threshold distance dthres and increases continuously with decreasing distance below the threshold distance dthres.

The situation illustrated in FIG. 7 is the same as in FIG. 6, except that the font size is kept at a minimum for an interval of distances that includes dthres rather than only at dthres (which is the case in FIG. 6).

The situation illustrated in FIG. 8 is similar to those in FIGS. 6 and 7, except that the increase in font size with increasing/decreasing distance is performed stepwise rather than continuously.

The term “continuously increasing” used above should not be interpreted literally, since the minimum usable difference between two font sizes in practice is a nonzero value determined e.g. by the number of bits used internally in the portable electronic device 1 for representing the font size and/or a resolution of the display 30. Hence, a literal continuous increase in font size would normally not be possible.

When a human being, such as the user 35, has difficulties in visually perceiving an object, such as the text displayed on the display 30, he normally strains his eyes, resulting in a change of eye gesture, in an effort to improve the visual perception. Normally, a human being would strain his eyes by peering for improving the visual perception. According to embodiments of the present invention, this can be detected by the control unit 40 from the image data received from the image sensor 20. In response thereto, the control unit 40 may adjust the font size of the text displayed on the display 30. For example, if the control unit 40 detects, based on the image data received from the image sensor 20 that the user 35 is peering, the control unit 40 may control the font size such that it is larger than when the user 35 is not peering.

Hence, according to some embodiments of the present invention, the control unit 40 is adapted to determine a current gesture of the eye of the user 35 based on the image data and to control the font size based on the determined current gesture. For example, the control unit 40 may be adapted to determine whether the determined current gesture belongs to a first set of gestures or a second set of gestures. Moreover, the control unit 40 may be adapted to control the font size such that the font size is larger if the determined current gesture belongs to the second set of gestures than if the determined current gesture belongs to the first set of gestures. The first set of gestures may indicate that the user's 35 eye is relaxed (or not peering) and the second set of gestures may indicate that the user's 35 eye is peering.

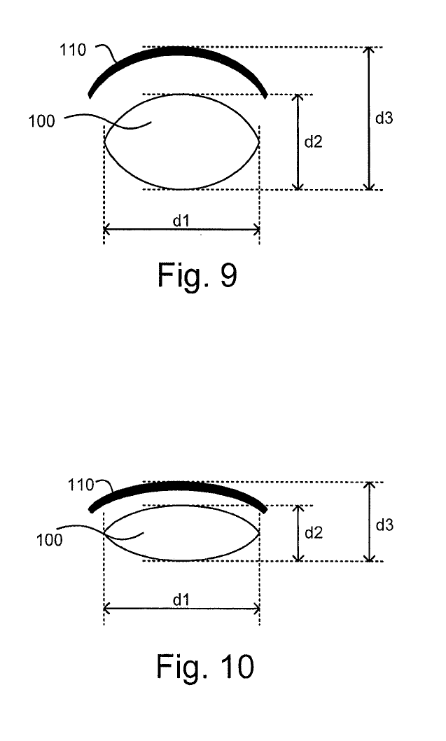

FIGS. 9 and 10 illustrate various examples of how the control unit 40 may determine a gesture of the user's 35 eye. FIG. 9 schematically illustrates the shape of an eye 100 of the user 35 when the user 35 is not peering. FIG. 9 also schematically illustrates the shape of a corresponding eye brow 110 of the user 35 when the user 35 is not peering. Indicated in FIG. 9, various characteristic distances that can be used for determining the current gesture of the eye 100 are indicated as well, namely: the width d1 of the eye 100, the height d2 of the eye 100, and the distance d3 from the bottom of the eye 100 to the top of the eye brow 110.

FIG. 10 shows the same thing as FIG. 9, but illustrates the situation when the user's 35 eye 100 is peering. Notable, the distances d2 and d3 are shorter compared with in FIG. 9. Accordingly, the ratios d2/d1 and d3/d1 are smaller when the eye 100 is peering compared with when the eye 100 is not peering. Hence these ratios may be utilized by the control unit 40 to determine the current gesture of the eye 100.

In order to determine the shape and position of the eye from the image data, the control unit 40 may employ an eye-recognition algorithm. Eye-recognition algorithms suitable for determining the shape and position of the eye from the image data are known, and are therefore not further described herein in any detail.

Other parts and/or features (e.g. forehead wrinkles) of the user's 35 face than the eye 100 and the eye brow 110, that can be detected via image recognition techniques an have different appearances depending on the user's 35 current eye gesture, may alternatively or additionally be used for determining the current eye gesture of the user 35.

The shapes of the eye of a person when the person is peering and not peering may naturally be different for different persons. In order to facilitate the determination of the current eye gesture of the user 35, the control unit 40 may employ a calibration routine for adapting the detection of the current eye gesture to the personal characteristics of the user 35. For example, the control unit 40 may be adapted to, in the calibration routine of the control unit 40, prompt the user 35 to perform a plurality of eye gestures and fetch, from the image sensor, one or more images of the user's eye for each gesture performed by the user. The gestures that the user 35 is prompted to perform may e.g. include “peering” and “not peering”. Furthermore, the control unit 40 may be adapted to determine the current gesture of the user's 35 eye by comparing characteristics of the (current) image data received from the image sensor 20 with corresponding characteristics of image data representing the images fetched from the image sensor 20 during the calibration routine. The characteristic of the (current) image data received from the image sensor may e.g. be the ratio d2/d1 and/or the ratio d3/d1. Alternatively, e.g. to avoid erroneously interpreting a blinking as peering, a plurality consecutive images may be taken into account. In that case, said characteristic may be e.g. be filtered values of d2/d1 and/or d3/d1, such as mean values of d2/d1 and/or d3/d1 over the plurality of consecutive images. The corresponding characteristics of the image data representing the images fetched from the image sensor 20 during the calibration routine may be values, or intervals of values, of the ratio d2/d1 and/or d3/d1 for different eye gestures. For example, if d2/d1 is used a characteristic for determining whether the user's 35 eye is peering, an interval of values of d2/d1 indicating that the user is peering may be derived during the calibration routine. If the current or filtered value of d2/d1 falls within this interval, it may be determined by the control unit 40 that the user's 35 eye is peering, and the font size may be controlled accordingly.

Above, one of the user's 35 eyes have been taken into account for controlling the font size. In some embodiments, the gesture of both eyes may be considered when controlling the font size.

The control of the font size based on distance between the portable electronic device 1 and the user's 35 face (e.g. as illustrated with examples in FIGS. 4-8) may be combined with the control based on the eye gesture as described above. The control unit 40 may e.g. be adapted to control the font size based on the distance d between the portable electronic device 1 and the user's 35 face differently depending on the user's 35 eye gesture. For example, if the user's 35 eye is not peering, the control unit 40 may control the font size according to one of the solid curves in FIGS. 4-8, whereas if the user's eye 35 is peering, the control unit 40 may control the font size according to the corresponding dashed curve (which in the examples in FIGS. 4-8 equals the solid curve plus a positive offset).

The present invention has been described above with reference to specific embodiments. However, other embodiments than the above described are possible within the scope of the invention. For example, in the embodiments described above, the font size of text displayed on the display 30 is controlled. However, the same kind of control may be applied to the size of one or more graphical objects, or images, displayed on the display 30. Furthermore, although embodiments of the present invention have been describe in the context of a portable electronic device 1, the same kind of control of font size and/or size of one or more graphical objects may be applied to non-portable electronic devices having a display for displaying text and/or graphics, such as but not limited to television sets, computer monitors, and the like. The different features of the invention may be combined in other combinations than those described. The scope of the invention is only limited by the appended patent claims.

1. An electronic device comprising:
a distance sensor for sensing a distance between the electronic device and a face of a user of the electronic device;
an image sensor for providing an image of the face of the user;
a display for displaying text and/or graphical objects; and
a control unit operatively connected to the display for controlling the displaying of text and/or a graphical object thereon, to the distance sensor for receiving distance data indicative of said distance, and to the image sensor for receiving image data representing said image; wherein
the control unit is adapted to control a font size of said text and/or a size of said graphical object based on the distance data and/or the image data.

2. The electronic device according to claim 1, wherein the control unit is adapted to control the font size and/or the size of said graphical object based on the distance data such that the font size and/or the size of said graphical object increases with an increasing distance between the electronic device and the face of the user.

3. The electronic device according to claim 1, wherein the control unit is adapted control the font size and/or the size of said graphical object based on the distance data such that the font size and/or the size of said graphical object increases with an increasing absolute difference between said distance between the electronic device and the face of the user and a threshold distance.

4. The electronic device according to claim 1, wherein the distance data comprises, for each of a plurality of directions, data indicative of a distance between the electronic device and an object closest to the electronic device in that direction, and the control unit is adapted to determine which of said directions is the direction towards the users face based on the image data.

5. The electronic device according to claim 1, wherein said distance data indicative of the distance between the electronic device and the face of the user is data indicative of the distance from the electronic device and the object closest to the electronic device that can be sensed by the distance sensor.

6. The electronic device according to claim 1, wherein the control unit is adapted to determine a current gesture of an eye of the user based on the image data and to control the font size and/or the size of said graphical object based on the determined current gesture.

7. The electronic device according to claim 6, wherein the control unit is adapted to
determine whether the determined current gesture belongs to a first set of gestures or a second set of gestures; and
control the font size and/or the size of said graphical object such that the font size and/or the size of said graphical object is larger if the determined current gesture belongs to the second set of gestures than if the determined current gesture belongs to the first set of gestures.

8. The electronic device according to claim 7, wherein the first set of gestures indicates that the user's eye is relaxed and the second set of gestures indicate that the user's eye is peering.

9. The electronic device according to claim 6, wherein the control unit is adapted to, in a calibration routine of the control unit:
prompt the user to perform a plurality of eye gestures;
fetch, from the image sensor, one or more images of the user for each gesture performed by the user.

10. The electronic device according to claim 9, wherein the control unit is adapted to determine the current gesture of the user's eye by comparing one or more characteristics of the image data received from the image sensor with one or more corresponding characteristics of image data representing the images fetched from the image sensor during the calibration routine.

11. The electronic device according to claim 1, wherein the electronic device is a portable electronic device.
